(19) United States
(12) Patent Application Publication
(10) Pub. No.: US 2025/0372905 A1
(43) Pub. Date: Dec. 4, 2025

(54) ELECTRODES HAVING DARK EXTERIOR SURFACE FINISHES AND SYSTEMS INCLUDING THE SAME

(71) Applicant: Meta Platforms Technologies, LLC, Menlo Park, CA (US)

(72) Inventors: Jianer Bao, Sunnyvale, CA (US); Jingye Li, Rockville, MD (US); Xiangying Ji, Shanghai (CN)

(21) Appl. No.: 19/220,542

(22) Filed: May 28, 2025

Related U.S. Application Data
(60) Provisional application No. 63/652,792, filed on May 29, 2024.

(51) Int. Cl. H01R 13/03; G02B 27/01; G06F 1/16; G06F 3/01

(52) U.S. Cl. CPC H01R 13/03; G02B 27/0176; G06F 1/163; G06F 3/014; G06F 3/016; G02B 2027/0152; G02B 2027/0178

(57) ABSTRACT

An apparatus of the subject technology includes an electrical contact formed by using a conductive element and the conductive element includes an electrically conductive base structure and a dark rhodium (Rh) contact layer covering an outer surface of the electrically conductive base structure.

### CROSS REFERENCE TO RELATED APPLICATIONS

This present application claims the benefit of priority under 35 U.S.C. § 119 (e) to U.S. Provisional Application No. 63/652,792, filed May 29, 2024, the disclosure of which is hereby incorporated by reference in its entirety for all purposes.

### TECHNICAL FIELD

The present disclosure generally relates to electronic systems, and more particularly, to electrodes having dark exterior surface finishes and systems including the same.

### BACKGROUND

For consumer electronics (CE) applications, metal contacts and connectors are often exposed to various corrosive liquids, such as sweat, salt water, and pool water. Additionally, liquid present on the contacts and connectors may lead to serious electrolysis-induced corrosion during charging or even during normal use conditions if the device being charged has a standing bias. Thus, for common CE applications such as mixed-reality (MR) devices including virtual reality (VR) and augmented reality (AR) devices, metals are desired to have very low contact resistance (e.g., low bulk resistance with no oxide film or a very thin oxide film at surface) but also superior corrosion resistance and wet charging resistance (e.g., electrolysis resistance).

### SUMMARY

In some aspects, the subject disclosure relates to an apparatus including an electrical contact formed by using a conductive element. The conductive element includes an electrically conductive base structure and a dark rhodium (Rh) contact layer covering an outer surface of the electrically conductive base structure.

In some other aspects, the subject disclosure relates to an MR device including an electrical contact used to measure biopotential parameters, the electrical contact using a conductive element. The conductive element includes an electrically conductive base structure including a plurality of stacked metal layers, and a dark contact layer covering an outer surface of the electrically conductive base structure.

In yet other aspects, the subject disclosure relates to a method including forming an electrical contact by forming a conductive element. The conductive element is made by forming an electrically conductive base structure and covering an outer surface of the electrically conductive base structure by a dark Rh contact layer.

### BRIEF DESCRIPTION OF THE DRAWINGS

To easily identify the discussion of any particular element or act, the most significant digit or digits in a reference number refer to the figure number in which that element is first introduced.

FIG. 1 is a chart illustrating an example plot of contact resistance versus normal force for different contact blackness, as discussed herein.

FIG. 2 is a chart illustrating an example plot of brightness and resistance at 50 gauge factor (GF), according to some aspects of the subject technology.

FIG. 3 is a chart illustrating an example plot of brightness and resistance at 70 GF, according to some aspects of the subject technology.

FIG. 4 is an illustration of exemplary wearable devices and systems that may be used in connection with some aspects of the subject technology.

FIG. 5 is an illustration of exemplary AR glasses that may be used in connection with some aspects of the subject technology.

FIG. 6 is an illustration of an exemplary VR headset that may be used in connection with some aspects of the subject technology.

FIG. 7 is an illustration of exemplary haptic devices that may be used in connection with some aspects of the subject technology.

FIG. 8 is an illustration of an exemplary VR environment according to some aspects of the subject technology.

FIG. 9 is an illustration of an exemplary AR environment that may be used in connection with some aspects of the subject technology.

FIG. 10 is a flow diagram illustrating an example of a method of fabricating electrodes having dark exterior surface finishes, according to some aspects of the subject technology.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various aspects described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that aspects of the present disclosure may be practiced without some of the specific details. In other instances, well-known structures and techniques have not been shown in detail so as not to obscure the disclosure.

Some aspects of the subject disclosure are generally directed to devices and systems that include electrodes having dark and/or black surface finishes. Dark (e.g., black) surface finishes for conductive metal contacts and connectors are desirable for charging and connector applications in a variety of CE applications, although such dark finishes are not common in current systems and are typically only used for very limited applications where biocompatibility is not a concern or where there is good corrosion resistance, high conductivity is not needed.

Additional challenges may increase difficulties in providing dark finishes for metal contacts. For example, metal surfaces are commonly not black due to their conductive nature, which inherently reflects a substantial amount of light. While metallic contacts having a black exterior finish have been developed, such contacts have various drawbacks that make them unsuitable for use in a number of CE applications. In one example, a conventional metallic contact may undergo a conversion process (e.g., chemical or additive) to provide a non-metal exterior surface layer that is not sufficiently conductive for many contact and connector applications. For example, black nickel, steel, copper, and/or zinc, which are blackened by a chemical conversion process, typically have compromised electrical conductivity, poor durability, and low sweat corrosion resistance. In some examples, black physical vapor deposition (PVD) materials, such as chromium carbide, doped titanium nitrides, conductive diamond-like carbon (DLC), and/or tetrahedral amorphous carbon (taC), may exhibit low conductivity and may present adhesion or corrosion problems with state of the art contact designs.

The black finishes of the electrodes of the subject technology may be formed on a variety of electrodes, including electrodes used in, for example, device charging and/or biopotential measurement applications. In some examples, electrodes may include a black rhodium (Rh) finish layer. In one example, a black finish may be achieved through a unique nano-porous microstructure that traps a significant proportion of incident light. Additionally, or alternatively, a black finish may be developed by a blackening agent during processing. Each of these exemplary types of black finish may provide reasonable contact resistance, allowing for a wide range of color and/or surface brightness, as discussed herein. In some examples, Rh finish layers may be configured to prevent substrate oxidation or corrosion. Rh finish layers may also be configured to prevent under-layer materials from diffusing to the surface and being oxidized/corroded. In some examples, electrodes with a black Rh finish may also show good solderability and bonding strength, making them suitable for charging contact and connector applications.

Because Rh is typically very expensive and deposited Rh may have high stresses and may be prone to crack, Rh alone may not be a solution for a reliable design. In some implementations, the disclosed electrode configurations may utilize a thin layer of black Rh that is deposited on a corrosion resistant, wet-charging-stable electrode design. An example thickness of the black Rh layer may be around a flash layer of approximately 0.025 μm up to approximately 0.75 μm. In some examples, the Rh layer thickness may be in a range of from approximately 0.05 μm to approximately 0.2 μm. A thin flash of regular Rh layer (0.025-0.1 μm) may be plated before plating dark Rh, to enhance adhesion. Due to the high hardness of Rh (i.e., approximately 800 Hv), even at a thin thickness, it is expected to last for the lifetime of a typical CE device. The low thickness Rh layer can reduce the cost impact as Rh is much more expensive than gold or other suitable conductive materials.

Stack designs that have relatively stable corrosion resistance and acceptable wet-charging performance, but relatively low cost, include the following designs. 1) CuSnZn or Ni (1-3 μm)+Au (0.1-2 μm)+Pt (0.1-1.5 μm); 2) Pd (0.1-1.5 μm)+Au (0.1-2 μm)+Pt (0.1-1.5 μm); 3) Pd (0.1-1.5 μm)+Ag (0.5-8 μm)+Au (0.1-2 μm)+Pt (0.1-1.5 μm) (Pd and Ag order could be changed); 4) Pd (0.1-1.5 μm)+Pt (0.1-1.5 μm); 5) a sandwiched structure like Pd (0.1-1 μm)+Au (0.1-1 μm)+Pt (0.1-1 μm)+Au (0.1-1 μm)+Pt (0.1-1 μm); and 6) Pd (0.1-1.5 μm)+Au (0.1-2 μm)+silver-Rh or Rh—Ru (0.1-1.5 μm).

There may also be other alloying elements in each of the coating layers, such as PdNi instead of Pd, or Ni/Co hardened Au instead of Au, etc. Thickness can vary depending on product use case and release specification (REL spec). The following are representative exemplary designs for each of the above stack design types. 1) CuSnZn (1.5-2.5 μm)+Au (0.5-1 μm)+Pt (0.5-1 μm); 2) Pd (0.125-1 μm)+Au (0.25-1 μm)+Pt (0.25-1 μm); 3) Pd (0.125-1 μm)+Ag (2-5 μm)+Au (0.25-1 μm)+Pt (0.25-1 μm); 4) Pd (0.125-1 μm)+Pt (0.25-1 μm); 5) Pt (0.125-0.75 μm)+Pd or Au (0.25-0.75 μm)+Pt (0.25-0.75 μm); and 6) Pd (0.125-1 μm)+Au (0.25-1 μm)+silver-Rh or Rh—Ru (0.25-0.75 μm).

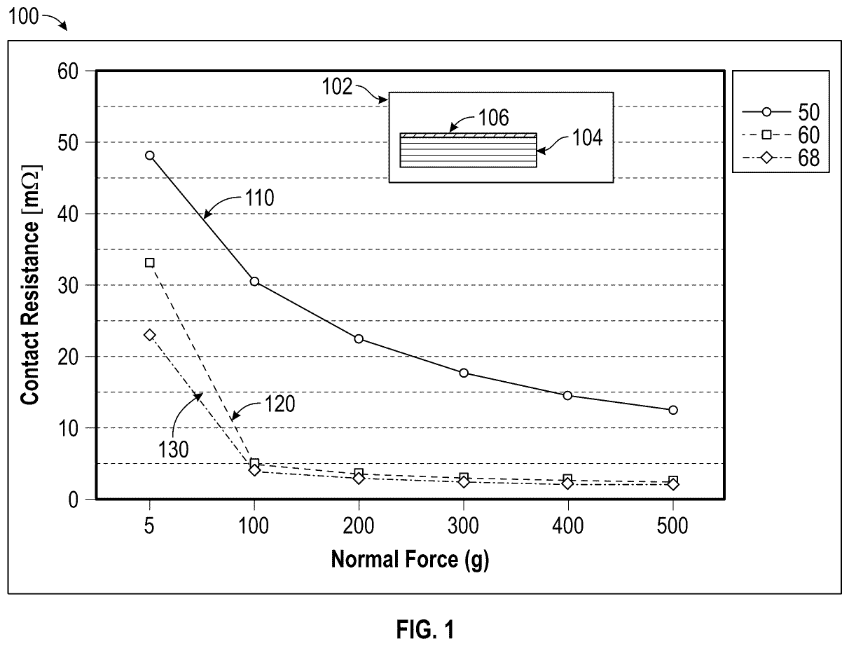

Turning now to the figures, FIG. 1 is a chart 100 illustrating example plots 110, 120 and 130 of contact resistance versus normal force for different contact blackness, as discussed herein. Plots 110, 120 and 130 could be related, for example, to an exemplary conductive element 102 of the subject technology made by forming an electrically conductive base structure 104 and covering the outer surface of the electrically conductive base structure 104 by a dark Rh contact layer 106.

Plot 110 corresponds to an L-value of 50. The L-value represents brightness, and in the context of contact resistance, the L-value is an indication of the amount of blackness additive used in forming the dark contact. An optimal design is expected to have an L-value within a range of about 50 to 55. Plot 110 shows that the contact resistance reduces with increasing normal force shown in gram (g) force. Plots 120 and 130 respectively correspond to L-values of 60 and 68 and indicate a lower contact resistance for almost all values of normal force. Plots 120 and 130, however, show less sensitivity to normal force after a normal force value of about 100. The resistance values would decrease further at higher forces that are still attainable. These results indicate that the resistances of the electrodes with various Rh finishes are suitable for use in charging applications as well as other electrode applications requiring conductivity via the Rh contact surface. The normal force is the force exerted when the contact resistance is measured against a gold (Au) bead target at a controlled force.

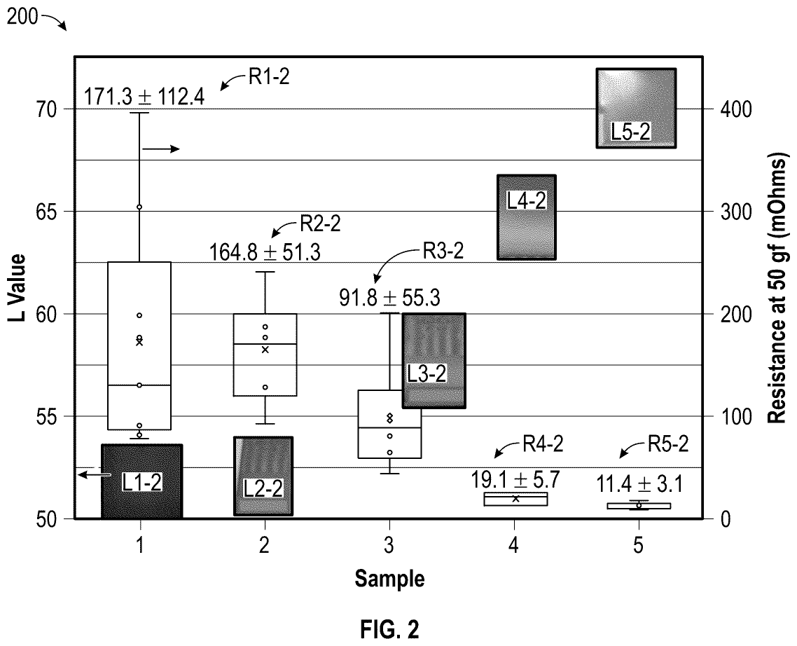

FIG. 2 is a chart illustrating an example plot of L-values and resistance at 50 gauge-factor (gf), according to some aspects of the subject technology. The black finishes of the electrodes of the subject technology may be formed on a variety of electrodes, including electrodes used in, for example, device charging and/or biopotential measurement applications. In some examples, electrodes may include a black rhodium (Rh) finish layer. In one example, a black finish may be achieved through a unique nano-porous microstructure that traps a significant proportion of incident light. Additionally, or alternatively, a black finish may be developed by a blackening agent during processing. Each of these exemplary types of black finish may provide reasonable contact resistance, allowing for a wide range of color and/or surface brightness, as shown and discussed herein.

Chart 200 of FIG. 2 shows ranges of contact resistances R1-2, R2-2, R3-2, R4-2 and R5-2 corresponding to samples 1 to 5 (the second index 2 refers to FIG. 2). Chart 200 also shows L-values by using color boxes L1-2, L2-2, L3-2, L4-2 and L5-2 corresponding to samples 1 to 5. As seen from chart 200, electrodes may range in brightness from an L-value from approximately 40 to approximately 80 with corresponding contact resistances of from approximately 5 mOhms (m (2) to approximately 200 mΩ within the force range of 30-100 gf.

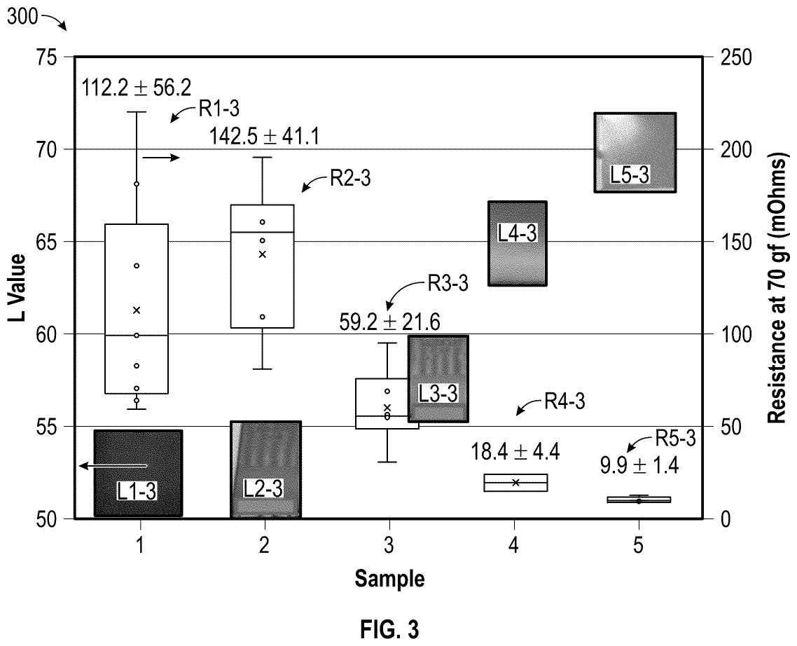

FIG. 3 is a chart 300 illustrating an example plot of brightness and resistance at 70 GF, according to some aspects of the subject technology. Chart 300 of FIG. 3 shows ranges of contact resistances R1-3, R2-3, R3-3, R4-3 and R5-3 corresponding to samples 1 to 5 (the second index 3 refers to FIG. 3). Chart 300 also shows L-values by using color boxes L1-3, L2-3, L3-3, L4-3 and L5-3 corresponding to samples 1 to 5. As seen from chart 200, electrodes may range in brightness from an L-value from approximately 40 to approximately 80 with corresponding contact resistances of from approximately 5 mOhms (mΩ) to approximately 200 mΩ within the force range of 30-100 gf. For example, as shown in FIGS. 2 and 3, sample electrodes with Rh finish layers exhibited the following brightness values (corresponding to surface finish darkness) and electrical resistance values shown in Table 1 when measured with a contact probe.

TABLE 1
Sample surface finish brightness and resistance values

| | | Resistance | Resistance |
|---|---|---|---|
| Sample No. | L-Value | at 50 gf | at 70 gf |
| 1 | ~50-55 | 171.3 ± 112.4 | 112.2 ± 56.2 |
| 2 | ~50 | 164.8 ± 51.3 | 142.5 ± 41.1 |
| 3 | ~50-60 | 91.8 ± 55.3 | 59.2 ± 21.6 |
| 4 | ~65 | 19.1 ± 5.7 | 18.4 ± 4.4 |
| 5 | ~70 | 11.4 ± 3.1 | 9.9 ± 1.4 |

The electrodes disclosed herein may be implemented into, conformed to, and/or suitably shaped to fit a variety of wearable devices and/or chargers for electronic devices. In some examples, the terms “wearable” and “wearable device” may refer to any type or form of computing device that is worn by a user of an artificial-reality system and/or visual display system as part of an article of clothing, an accessory, and/or an implant. In one example, a wearable device may include and/or represent a wristband secured to and/or worn by the wrist of a user. Additional examples of wearable devices include, without limitation, armbands, pendants, bracelets, rings, jewelry, ankle bands, clothing, electronic textiles, shoes, clips, headsets, headbands, head-mounted displays, gloves, glasses, variations or combinations of one or more of the same, and/or any other suitable wearable devices.

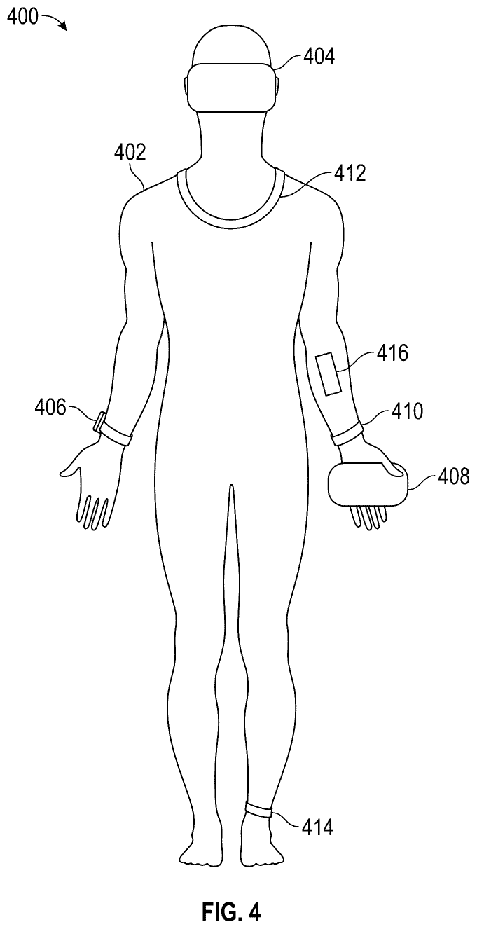

FIG. 4 is an illustration of exemplary wearable devices and systems that may be used in connection with some aspects of the subject technology. The disclosed bio-signal systems may be implemented into one or more of the devices, in example systems 400 shown in FIG. 4. As illustrated in this figure, system 400 may include a user 402 and computing devices that are worn or held by user 402. For example, FIG. 4 shows a head-mounted display system 404, worn on the head of user 402. FIG. 4 further shows a smart watch 406 worn on a wrist of user 402, a smart phone 408 or other portable device held in a hand of user 402, an electronic device 410 worn on a wrist of user 402, an electronic device 412 worn about the neck region of user 402, an electronic device 414 worn on an ankle of user 402, and a flexible electronic device 416 worn on a forearm of user 402. In some examples, one or more of the devices shown in FIG. 4 may be shaped to conform to a corresponding portion of the wearer's body.

The various devices, systems, and methods described herein may involve the use of a wearable device capable of detecting and/or sensing neuromuscular signals traversing through a user's body. For example, a user may wear a smart wristband with multiple surface electromyography (EMG) sensors that detect and/or sense neuromuscular signals traversing the user's arm, wrist, and/or hand. In this example, the smart wristband may be communicatively coupled to a nearby computing device. In response to certain neuromuscular signals detected via the user's body, the smart wristband may direct the computing device to perform one or more actions that account for those neuromuscular signals.

Accordingly, the smart wristband may enable the user to engage with interactive media presented and/or displayed on the computing device in less restrictive ways than traditional human-computer interactions (HCIs). The smart wristband may be used to control certain elements of interactive media based at least in part on EMG signals that correlate to predefined states of one or more body parts of the user. The smart wristband may enable the user to direct the computing device to perform certain interactive tasks. Examples of such interactive tasks include, without limitation, map navigation, page browsing, gaming controls, flight controls, interactions with graphical objects presented on a display, cursor control, link and/or button selection, combinations of one or more of the same, and/or any other suitable interactive tasks.

In some implementations, a wearable device may be used to transition between different mappings of body part states and responsive actions. For example, the wearable device may detect and/or sense certain neuromuscular signals traversing a user's body. In this example, those neuromuscular signals may correspond to and/or represent a specific state of one or more of the user's body parts. As a result, the wearable device may be able to detect and/or sense one or more positions, movements, forces, contractions, poses, and/or gestures made by those body parts of the user. One mapping may cause the wearable device and/or the target computing device to perform a certain action in response to the detection of a specific state of those body parts. However, another mapping may cause the wearable device and/or the target computing device to perform a different action in response to the detection of the same state of those body parts. The wearable device may enable the user to transition between those mappings via neuromuscular signals.

Aspects of the present disclosure may include or be implemented in conjunction with various types of artificial reality systems. Artificial reality is a form of reality that has been adjusted in some manner before presentation to a user, which may include, for example, an MR, a VR, an AR, an extended reality (XR), a hybrid reality (HR), or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some aspects, artificial reality may also be associated with applications, products, accessories, services, or some combination thereof, that are used to, for example, create content in an artificial reality and/or are otherwise used in (e.g., to perform activities in) an artificial reality.

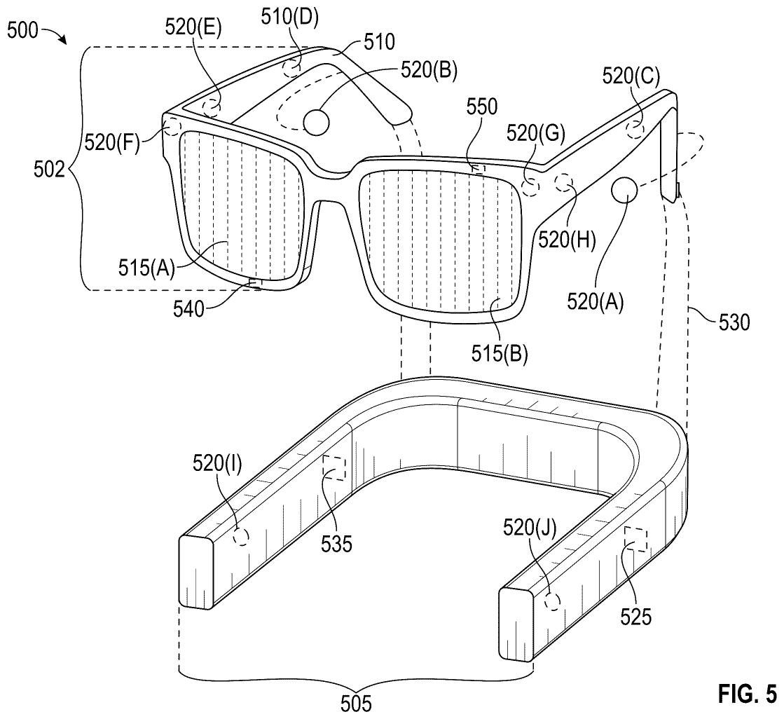

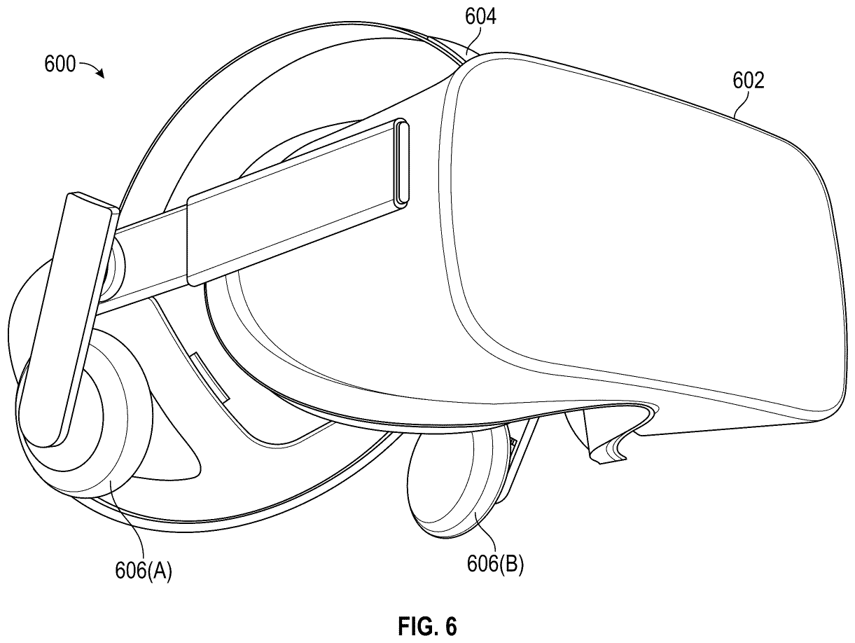

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., AR system 500 in FIG. 5) or that visually immerses a user in an artificial reality (such as, e.g., VR system 600 in FIG. 6). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

FIG. 5 is an illustration of exemplary augmented-reality glasses that may be used in connection with some aspects of the subject technology. The augmented-reality system 500 may include an eyewear device 502 with a frame 510 configured to hold a left display device 515(A) and a right display device 515(B) in front of a user's eyes. Display devices 515(A) and 515(B) may act together or independently to present an image or series of images to a user. While augmented-reality system 500 includes two displays, aspects of this disclosure may be implemented in augmented-reality systems with a single NED or more than two NEDs.

In some aspects, augmented-reality system 500 may include one or more sensors, such as sensor 540. Sensor 540 may generate measurement signals in response to motion of augmented-reality system 500 and may be located on substantially any portion of frame 510. Sensor 540 may represent one or more of a variety of different sensing mechanisms, such as a position sensor, an inertial measurement unit (IMU), a depth camera assembly, a structured light emitter and/or detector, or any combination thereof. In some aspects, augmented-reality system 500 may or may not include sensor 540 or may include more than one sensor. In aspects in which sensor 540 includes an IMU, the IMU may generate calibration data based on measurement signals from sensor 540. Examples of sensor 540 may include, without limitation, accelerometers, gyroscopes, magnetometers, other suitable types of sensors that detect motion, sensors used for error correction of the IMU, or some combination thereof.

In some examples, augmented-reality system 500 may also include a microphone array with a plurality of acoustic transducers 520(A)-520(J), referred to collectively as acoustic transducers 520. Acoustic transducers 520 may represent transducers that detect air pressure variations induced by sound waves. Each acoustic transducer 520 may be configured to detect sound and convert the detected sound into an electronic format (e.g., an analog or digital format). The microphone array in FIG. 5 may include, for example, ten acoustic transducers: 520(A) and 520(B), which may be designed to be placed inside a corresponding ear of the user, acoustic transducers 520(C), 520(D), 520(E), 520(F), 520(G), and 520(H), which may be positioned at various locations on frame 510, and/or acoustic transducers 520(I) and 520(J), which may be positioned on a corresponding neckband 505.

In some aspects, one or more acoustic transducers 520(A)-(J) may be used as output transducers (e.g., speakers). For example, acoustic transducers 520(A) and/or 520(B) may be earbuds or any other suitable type of headphone or speaker. The configuration of acoustic transducers 520 of the microphone array may vary. While augmented-reality system 500 is shown in FIG. 5 as having ten acoustic transducers 520, the number of acoustic transducers 520 may be greater or less than ten. In some aspects, using higher numbers of acoustic transducers 520 may increase the amount of audio information collected and/or the sensitivity and accuracy of the audio information. In contrast, using a lower number of acoustic transducers 520 may decrease the computing power required by an associated controller 550 to process the collected audio information. In addition, the position of each acoustic transducer 520 of the microphone array may vary. For example, the position of an acoustic transducer 520 may include a defined position on the user, a defined coordinate on frame 510, an orientation associated with each acoustic transducer 520, or some combination thereof.

Acoustic transducers 520(A) and 520(B) may be positioned on different parts of the user's ear, such as behind the pinna, behind the tragus, and/or within the auricle or fossa. Or, there may be additional acoustic transducers 520 on or surrounding the ear in addition to acoustic transducers 520 inside the ear canal. Having an acoustic transducer 520 positioned next to an ear canal of a user may enable the microphone array to collect information on how sounds arrive at the ear canal. By positioning at least two of acoustic transducers 520 on either side of a user's head (e.g., as binaural microphones), augmented-reality device 500 may simulate binaural hearing and capture a 3D stereo sound field around about a user's head. In some aspects, acoustic transducers 520(A) and 520(B) may be connected to augmented-reality system 500 via a wired connection 530, and in other aspects acoustic transducers 520(A) and 520(B) may be connected to augmented-reality system 500 via a wireless connection (e.g., a Bluetooth connection). In still other aspects, acoustic transducers 520(A) and 520(B) may not be used at all in conjunction with augmented-reality system 500.

Acoustic transducers 520 on frame 510 may be positioned in a variety of different ways, including along the length of the temples, across the bridge, above or below display devices 515(A) and 515(B), or some combination thereof. Acoustic transducers 520 may also be oriented such that the microphone array is able to detect sounds in a wide range of directions surrounding the user wearing the augmented-reality system 500. In some aspects, an optimization process may be performed during manufacturing of augmented-reality system 500 to determine relative positioning of each acoustic transducer 520 in the microphone array.

In some examples, augmented-reality system 500 may include or be connected to an external device (e.g., a paired device), such as neckband 505. Neckband 505 generally represents any type or form of paired device. Thus, the following discussion of neckband 505 may also apply to various other paired devices, such as charging cases, smart watches, smart phones, wrist bands, other wearable devices, hand-held controllers, tablet computers, laptop computers, other external computing devices, etc. As shown, neckband 505 may be coupled to eyewear device 502 via one or more connectors. The connectors may be wired or wireless and may include electrical and/or non-electrical (e.g., structural) components. In some cases, eyewear device 502 and neckband 505 may operate independently without any wired or wireless connection between them.

While FIG. 5 illustrates the components of eyewear device 502 and neckband 505 in example locations on eyewear device 502 and neckband 505, the components may be located elsewhere and/or distributed differently on eyewear device 502 and/or neckband 505. In some aspects, the components of eyewear device 502 and neckband 505 may be located on one or more additional peripheral devices paired with eyewear device 502, neckband 505, or some combination thereof. Pairing external devices, such as neckband 505, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 500 may be provided by a paired device or shared between a paired device and an eyewear device, thus reducing the weight, heat profile, and form factor of the eyewear device overall while still retaining desired functionality. For example, neckband 505 may allow components that would otherwise be included on an eyewear device to be included in neckband 505 since users may tolerate a heavier weight load on their shoulders than they would tolerate on their heads. Neckband 505 may also have a larger surface area over which to diffuse and disperse heat to the ambient environment. Thus, neckband 505 may allow for greater battery and computation capacity than might otherwise have been possible on a stand-alone eyewear device. Since weight carried in neckband 505 may be less invasive to a user than weight carried in eyewear device 502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 505 may be communicatively coupled with eyewear device 502 and/or to other devices. These other devices may provide certain functions (e.g., tracking, localizing, depth mapping, processing, storage, etc.) to augmented-reality system 500. In the implementation of FIG. 5, neckband 505 may include two acoustic transducers (e.g., 520(I) and 520(J)) that are part of the microphone array (or potentially form their own microphone subarray). Neckband 505 may also include a controller 525 and a power source 535.

Acoustic transducers 520(I) and 520(J) of neckband 505 may be configured to detect sound and convert the detected sound into an electronic format (analog or digital). In the implementation of FIG. 5, acoustic transducers 520(I) and 520(J) may be positioned on neckband 505, thereby increasing the distance between the neckband acoustic transducers 520(I) and 520(J) and other acoustic transducers 520 positioned on eyewear device 502. In some cases, increasing the distance between acoustic transducers 520 of the microphone array may improve the accuracy of beamforming performed via the microphone array. For example, if a sound is detected by acoustic transducers 520(C) and 520(D) and the distance between acoustic transducers 520(C) and 520(D) is greater than, e.g., the distance between acoustic transducers 520(D) and 520(E), the determined source location of the detected sound may be more accurate than if the sound had been detected by acoustic transducers 520(D) and 520(E).

Controller 525 of neckband 505 may process information generated by the sensors on neckband 505 and/or augmented-reality system 500. For example, controller 525 may process information from the microphone array that describes sounds detected by the microphone array. For each detected sound, controller 525 may perform a direction-of-arrival (DOA) estimation to estimate a direction from which the detected sound arrived at the microphone array. As the microphone array detects sounds, controller 525 may populate an audio data set with the information. In implementations in which augmented-reality system 500 includes an inertial measurement unit, controller 525 may compute all inertial and spatial calculations from the IMU located on eyewear device 502. A connector may convey information between augmented-reality system 500 and neckband 505 and between augmented-reality system 500 and controller 525. The information may be in the form of optical data, electrical data, wireless data, or any other transmittable data form. Moving the processing of information generated by augmented-reality system 500 to neckband 505 may reduce weight and heat in eyewear device 502, making it more comfortable to the user.

Power source 535 in neckband 505 may provide power to eyewear device 502 and/or to neckband 505. Power source 535 may include, without limitation, lithium-ion batteries, lithium-polymer batteries, primary lithium batteries, alkaline batteries, or any other form of power storage. In some cases, power source 535 may be a wired power source. Including power source 535 on neckband 505 instead of on eyewear device 502 may help better distribute the weight and heat generated by power source 535.

FIG. 6 is an illustration of an exemplary VR headset that may be used in connection with some aspects of the subject technology. As noted, some artificial-reality systems may, instead of blending an artificial reality with actual reality, substantially replace one or more of a user's sensory perceptions of the real world with a virtual experience. One example of this type of system is a head-worn display system, such as virtual-reality system 600 in FIG. 6, that mostly or completely covers a user's field of view. Virtual-reality system 600 may include a front rigid body 602 and a band 604 shaped to fit around a user's head. Virtual-reality system 600 may also include output audio transducers 606(A) and 606(B). Furthermore, while not shown in FIG. 6, front rigid body 602 may include one or more electronic elements, including one or more electronic displays, one or more IMUs, one or more tracking emitters or detectors, and/or any other suitable device or system for creating an artificial-reality experience.

Artificial-reality systems may include a variety of types of visual feedback mechanisms. For example, display devices in augmented-reality system 500 and/or VR system 600 may include one or more liquid crystal displays (LCDs), light emitting diode (LED) displays, micro-LED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 500 and/or VR system 600 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 500 and/or VR system 600 may include one or more optical sensors, such as two-dimensional (2D) or 6D cameras, structured light transmitters and detectors, time-of-flight depth sensors, single-beam or sweeping laser rangefinders, 6D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some aspects, a single transducer may be used for both audio input and audio output.

In some aspects, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The aspects disclosed herein may enable or enhance a user's artificial-reality experience in one or more of these contexts and environments and/or in other contexts and environments.

As noted, artificial-reality systems 500 and VR system 600 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

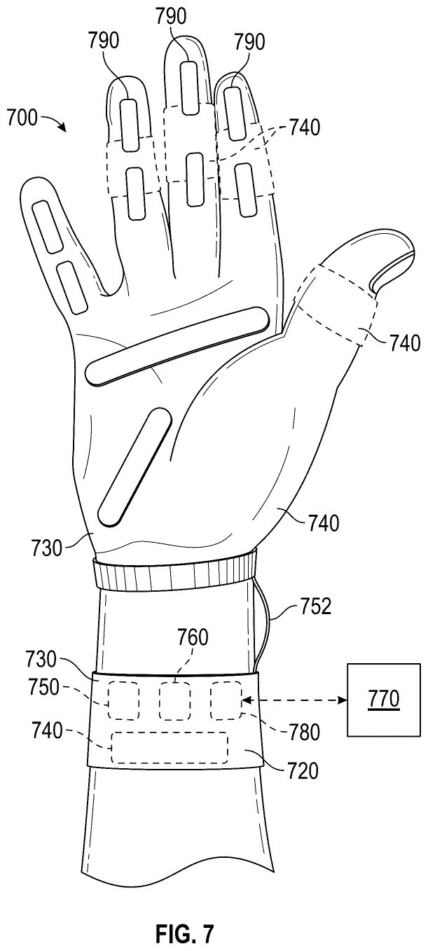

FIG. 7 is an illustration of exemplary haptic devices that may be used in connection with some aspects of the subject technology. Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 7 illustrates a vibrotactile system 700 in the form of a wearable glove (haptic device 710) and wristband (haptic device 720). Haptic device 710 and haptic device 720 are shown as examples of wearable devices that include a flexible, wearable textile material 730 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various aspects of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 740 may be positioned at least partially within one or more corresponding pockets formed in textile material 730 of vibrotactile system 700. Vibrotactile devices 740 may be positioned in locations to provide a vibrating sensation (e.g., haptic feedback) to a user of vibrotactile system 700. For example, vibrotactile devices 740 may be positioned against the user's finger(s), thumb, or wrist, as shown in FIG. 7. Vibrotactile devices 740 may, in some examples, be sufficiently flexible to conform to or bend with the user's corresponding body part(s). A power source 750 (e.g., a battery) for applying a voltage to the vibrotactile devices 740 for activation thereof may be electrically coupled to vibrotactile devices 740, such as via conductive wiring 752. In some examples, each of vibrotactile devices 740 may be independently electrically coupled to power source 750 for individual activation. In some aspects, a processor 760 may be operatively coupled to power source 750 and configured (e.g., programmed) to control activation of vibrotactile devices 740.

Vibrotactile system 700 may be implemented in a variety of ways. In some examples, vibrotactile system 700 may be a standalone system with integral subsystems and components for operation independent of other devices and systems. As another example, vibrotactile system 700 may be configured for interaction with another device or system 770. For example, vibrotactile system 700 may, in some examples, include a communications interface 780 for receiving and/or sending signals to the other device or system 770. The other device or system 770 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 780 may enable communications between vibrotactile system 700 and the other device or system 770 via a wireless (e.g., Wi-Fi, BLUETOOTH, cellular, radio, etc.) link or a wired link. If present, communications interface 780 may be in communication with processor 760, such as to provide a signal to processor 760 to activate or deactivate one or more of the vibrotactile devices 740.

Vibrotactile system 700 may optionally include other subsystems and components, such as touch-sensitive pads 790, pressure sensors, motion sensors, position sensors, lighting elements, and/or user interface elements (e.g., an on/off button, a vibration control element, etc.). During use, vibrotactile devices 740 may be configured to be activated for a variety of different reasons, such as in response to the user's interaction with user interface elements, a signal from the motion or position sensors, a signal from the touch-sensitive pads 790, a signal from the pressure sensors, a signal from the other device or system 770, etc. Although power source 750, processor 760, and communications interface 780 are illustrated in FIG. 7 as being positioned in haptic device 710, the present disclosure is not so limited. For example, one or more power source 750, processor 760, or communications interface 780 may be positioned within haptic device 710 or within another wearable textile.

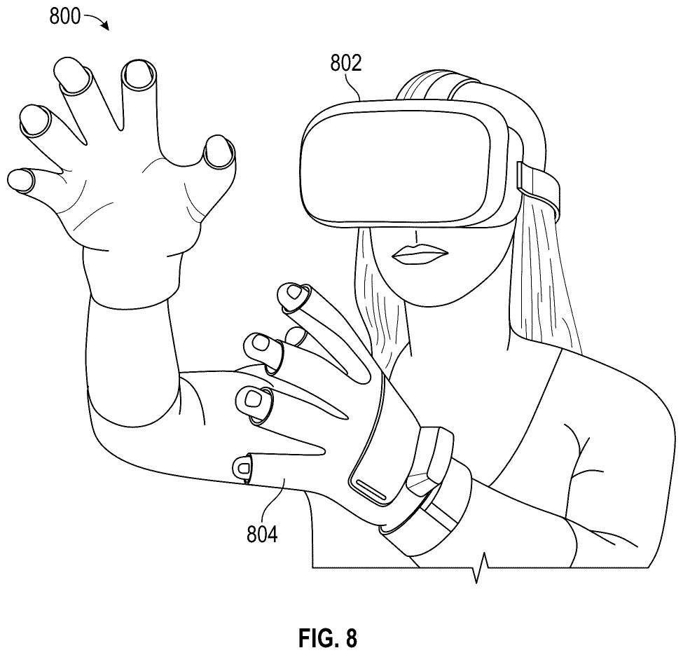

FIG. 8 is an illustration of an exemplary virtual-reality environment according to some aspects of the subject technology. Haptic wearables, such as those shown in and described in connection with FIG. 7, may be implemented in a variety of types of artificial-reality systems and environments. FIG. 8 shows an example artificial-reality environment 800 including one head-mounted virtual-reality display and two haptic devices (i.e., gloves), and in other aspects any number and/or combination of these components and other components may be included in an artificial-reality system. For example, in some aspects, there may be multiple head-mounted displays each having an associated haptic device, with each head-mounted display and each haptic device communicating with the same console, portable computing device, or other computing system.

Head-mounted display 802 generally represents any type or form of virtual-reality system, such as virtual-reality system 600 in FIG. 6. Haptic device 804 generally represents any type or form of wearable device, worn by a user of an artificial-reality system, that provides haptic feedback to the user to give the user the perception that he or she is physically engaging with a virtual object. In some aspects, haptic device 804 may provide haptic feedback by applying vibration, motion, and/or force to the user. For example, haptic device 804 may limit or augment a user's movement. To give a specific example, haptic device 804 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 804 to send action requests to a console. Examples of action requests include, without limitation, requests to start an application and/or end the application and/or requests to perform a particular action within the application.

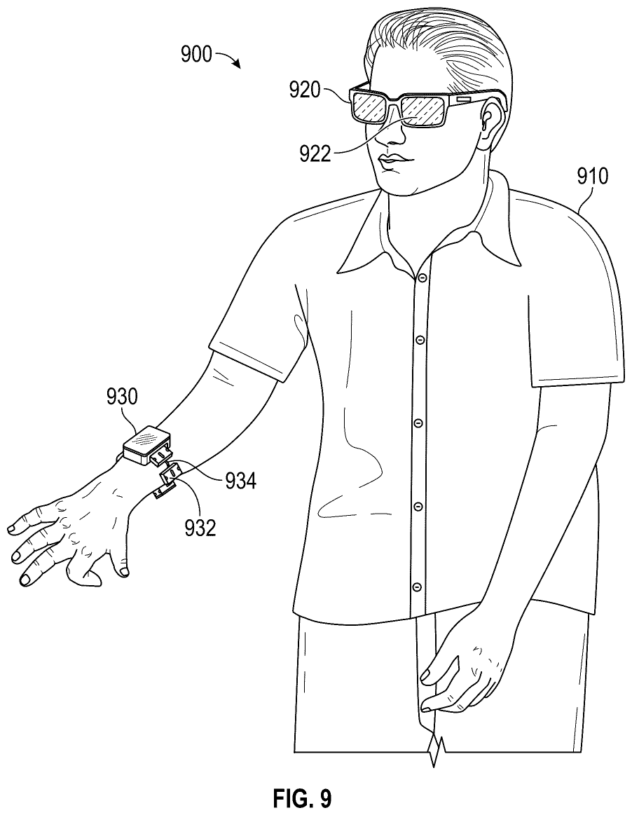

FIG. 9 is an illustration of an exemplary augmented-reality environment that may be used in connection with some aspects of the subject technology. While haptic interfaces may be used with virtual-reality systems, as shown in FIG. 8, haptic interfaces may also be used with augmented-reality systems, as shown in FIG. 9. FIG. 9 is a perspective view of a user 910 interacting with an augmented-reality system 900. In this example, user 910 may wear a pair of augmented-reality glasses 920 that may have one or more displays 922 and that are paired with a haptic device 930. In this example, haptic device 930 may be a wristband that includes a plurality of band elements 932 and a tensioning mechanism 934 that connects band elements 932 to one another.

One or more band elements 932 may include any type or form of actuator suitable for providing haptic feedback. For example, one or more of band elements 932 may be configured to provide one or more of various types of cutaneous feedback, including vibration, force, traction, texture, and/or temperature. To provide such feedback, band elements 932 may include one or more of various types of actuators. In one example, each of band elements 932 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 710, 720, 804, and 930 may include any suitable number and/or type of haptic transducer, sensor, and/or feedback mechanism. For example, haptic devices 710, 720, 804, and 930 may include one or more mechanical transducers, piezoelectric transducers, and/or fluidic transducers. Haptic devices 710, 720, 804, and 930 may also include various combinations of different types and forms of transducers that work together or independently to enhance a user's artificial-reality experience. In one example, each of band elements 932 of haptic device 930 may include a vibrotactor (e.g., a vibrotactile actuator) configured to vibrate in unison or independently to provide one or more of various types of haptic sensations to a user.

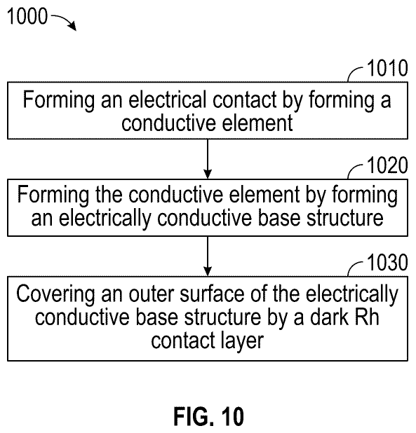

FIG. 10 is a flow diagram illustrating an example of a method 1000 for fabricating electrodes having dark exterior surface finishes, according to some aspects of the subject technology. Method 1000 includes steps 1010, 1020, and 1030.

In step 1010, an electrical contact is made by forming a conductive element (e.g., 102 of FIG. 1).

In step 1020, the conductive element is made by forming an electrically conductive base structure (e.g., 104 of FIG. 1).

In step 1030, an outer surface of the electrically conductive base structure is covered by a dark Rh contact layer (e.g., 106 of FIG. 1).

An aspect of the subject technology is directed to an apparatus including an electrical contact formed by using a conductive element. The conductive element includes an electrically conductive base structure and a dark rhodium (Rh) contact layer covering an outer surface of the electrically conductive base structure.

In some implementations, the electrically conductive base structure comprises several stacked metal layers.

In one or more implementations, the stacked metal layers comprise at least one layer comprising platinum (Pt), silver (Ag)—Rh or Rh-Ruthenium (Ru).

In some implementations, the stacked metal layers comprise at least one layer comprising palladium (Pd) or silver (Ag).

In one or more implementations, a layer of the stacked metal layers has a thickness within a range of approximately 0.05 μm to approximately 10 μm.

In some implementations, the dark Rh contact layer has a surface finish with an L-value within a range of approximately 40 to approximately 80.

In one or more implementations, the dark Rh contact layer exhibits an electrical resistance of from approximately 5 mOhms to approximately 200 mOhms under a contact force within a range of approximately 30 gf to approximately 100 gf.

In some implementations, the electrical contact includes electrodes used in several applications including device charging and biopotential measurement applications.

Another aspect of the subject technology is directed to an MR device including an electrical contact used to measure biopotential parameters, the electrical contact using a conductive element. The conductive element include an electrically conductive base structure including a plurality of stacked metal layers, and a dark contact layer covering an outer surface of the electrically conductive base structure.

In some implementations, the dark contact layer comprises Rh, and wherein the dark Rh contact layer has a surface finish with an L-value within a range of approximately 40 to approximately 80.

In one or more implementations, the electrically conductive base structure comprises a plurality of stacked metal layers, and wherein the plurality of stacked metal layers comprises at least one layer comprising Au.

In some implementations, the plurality of stacked metal layers comprises at least one layer comprising Pt, Ag—Rh or Rh—Ru.

In one or more implementations, the plurality of stacked metal layers comprises at least one layer comprising Pd or Ag.

In some implementations, a layer of the plurality of stacked metal layers has a thickness within a range of approximately 0.05 μm to approximately 10 μm.

Yet another aspect of the subject technology is directed to a method including forming an electrical contact by forming a conductive element. The conductive element is made by forming an electrically conductive base structure and covering an outer surface of the electrically conductive base structure by a dark Rh contact layer.

In one or more implementations, the dark Rh contact layer has a surface finish with an L-value within a range of approximately 40 to approximately 80, and the dark Rh contact layer has a thickness within a range of approximately 0.025 μm to approximately 0.75 μm.

In some implementations, the electrically conductive base structure comprises several stacked metal layers, the stacked metal layers comprise at least one layer comprising Au, the stacked metal layers comprise at least one layer comprising Pd or Ag, a layer of the stacked metal layers has a thickness within a range of approximately 0.05 μm to approximately 10 μm, and the stacked metal layers comprise at least one layer comprising Pt, Ag—Rh or Rh—Ru.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An apparatus, comprising:
an electrical contact formed by using a conductive element comprising:
an electrically conductive base structure; and
a dark rhodium (Rh) contact layer covering an outer surface of the electrically conductive base structure.

2. The apparatus of claim 1, wherein the dark Rh contact layer has a thickness within a range of approximately 0.025 micrometer (μm) to approximately 0.75 μm.

3. The apparatus of claim 2, wherein the electrically conductive base structure comprises a plurality of stacked metal layers.

4. The apparatus of claim 3, wherein the plurality of stacked metal layers comprises at least one layer comprising gold (Au).

5. The apparatus of claim 3, wherein the plurality of stacked metal layers comprises at least one layer comprising platinum (Pt), silver (Ag)—Rh or Rh-Ruthenium (Ru).

6. The apparatus of claim 3, wherein the plurality of stacked metal layers comprises at least one layer comprising palladium (Pd) or silver (Ag).

7. The apparatus of claim 3, wherein a layer of the plurality of stacked metal layers has a thickness within a range of approximately 0.05 μm to approximately 10 μm.

8. The apparatus of claim 1, wherein the dark Rh contact layer has a surface finish with an L-value within a range of approximately 40 to approximately 80.

9. The apparatus of claim 1, wherein the dark Rh contact layer exhibits an electrical resistance of from approximately 5 mOhms to approximately 200 mOhms under a contact force within a range of approximately 30 gf to approximately 100 gf.

10. The apparatus of claim 1, wherein the electrical contact includes electrodes used in several applications including device charging and biopotential measurement applications.

11. A mixed reality (MR) device, comprising:
an electrical contact configured to measure biopotential parameters, the electrical contact using a conductive element comprising:
an electrically conductive base structure including a plurality of stacked metal layers; and
a dark contact layer covering an outer surface of the electrically conductive base structure.

12. The MR device of claim 11, wherein the dark contact layer comprises Rh, and wherein the dark contact layer has a surface finish with an L-value within a range of approximately 40 to approximately 80.

13. The MR device of claim 11, wherein the electrically conductive base structure comprises a plurality of stacked metal layers, and wherein the plurality of stacked metal layers comprises at least one layer comprising Au.

14. The MR device of claim 13, wherein the plurality of stacked metal layers comprises at least one layer comprising Pt, Ag—Rh or Rh—Ru.

15. The MR device of claim 13, wherein the plurality of stacked metal layers comprises at least one layer comprising Pd or Ag.

16. The MR device of claim 13, wherein a layer of the plurality of stacked metal layers has a thickness within a range of approximately 0.05 μm to approximately 10 μm.

17. The MR device of claim 13, wherein:
a layer of the plurality of stacked metal layers has a thickness within a range of approximately 0.05 μm to approximately 10 μm; and
the dark contact layer has a thickness within a range of approximately 0.025 μm to approximately 0.75 μm.

18. A method, comprising:
forming an electrical contact by forming a conductive element; and
forming the conductive element by:
forming an electrically conductive base structure; and
covering an outer surface of the electrically conductive base structure by a dark Rh contact layer.

19. The method of claim 18, wherein:
the dark Rh contact layer has a surface finish with an L-value within a range of approximately 40 to approximately 80; and
the dark Rh contact layer has a thickness within a range of approximately 0.025 μm to approximately 0.75 μm.

20. The method of claim 19, wherein:
the electrically conductive base structure comprises a plurality of stacked metal layers;
the plurality of stacked metal layers comprises at least one layer comprising Au;
the plurality of stacked metal layers comprises at least one layer comprising Pd or Ag;
a layer of the plurality of stacked metal layers has a thickness within a range of approximately 0.05 μm to approximately 10 μm; and
the plurality of stacked metal layers comprises at least one layer comprising Pt, Ag—Rh or Rh—Ru.
